(19) United States
(12) Patent Application Publication
(10) Pub. No.: US 2026/0197856 A1
(43) Pub. Date: Jul. 9, 2026

(54) METHOD AND DEVICE FOR BEAM SELECTION IN WIRELESS COMMUNICATION SYSTEM

(71) Applicant: Samsung Electronics Co., Ltd., Suwon-si (KR)

(72) Inventors: Myungjin KANG, Suwon-si (KR); Hyungjoon YU, Suwon-si (KR); Youngkwon LEE, Suwon-si (KR); Suwan KIM, Suwon-si (KR); Youngsub YOON, Suwon-si (KR); Jongphil LEE, Suwon-si (KR)

(21) Appl. No.: 19/554,368

(22) Filed: Mar. 2, 2026

Related U.S. Application Data
(63) Continuation of application No. PCT/KR2024/012220, filed on Aug. 16, 2024.

(30) Foreign Application Priority Data
Sep. 6, 2023 (KR) 10-2023-0118292
Oct. 20, 2023 (KR) 10-2023-0141296

(51) Int. Cl. H04W 72/542; H04W 72/044

(52) U.S. Cl. CPC H04W 72/542; H04W 72/046

(57) ABSTRACT

An electronic device may include a processor and a memory. The processor may: acquire information related to signal strengths of a plurality of beams by using an SS/PBCH block and/or a channel state information reference signal (CSI-RS) included in a transmission beam; acquire information about signal strengths for a vertical (V)-beam component and a horizontal (H)-beam component of the plurality of beams; determine a first beam index on the basis of the acquired information related to the signal strength for the V-beam component; determine a second beam index on the basis of the acquired information related to the signal strength for the H-beam component; and receive a signal by using the V-beam component of the first beam index and the H-beam component of the second beam index among the plurality of beams.

### CROSS-REFERENCE TO RELATED APPLICATIONS

This application is a continuation application of International Application No. PCT/KR2024/012220 designating the United States, filed on Aug. 16, 2024, in the Korean Intellectual Property Receiving Office and claiming priority to Korean Patent Application No. 10-2023-0118292, filed on Sept. 6, 2023, and Korean Patent Application No. 10-2023-0141296, filed on Oct. 20, 2023, the disclosures of which are all hereby incorporated by reference herein in their entireties.

### TECHNICAL FIELD

Certain example embodiments may relate to an electronic device, and for example to an electronic device that performs a method for beam selection in a wireless communication system.

### BACKGROUND ART

In order to satisfy a demand for wireless data traffic that is in an increasing trend after commercialization of a 4G communication system, efforts are being made to develop an improved 5G communication system or a pre-5G communication system. For this reason, the 5G communication system or the pre-5G communication system is being called a communication system after a 4G network (Beyond 4G Network) communication system or a system after an LTE system (Post LTE) thereafter. In order to achieve a high data transmission rate, the 5G communication system is also being considered for implementation in an ultra-high frequency (mmWave) band (for example, a band such as a band of 6 giga (6 GHz) or more) in addition to a band used by LTE (a band of 6 giga (6 GHz) or less). In the 5G communication system, beamforming, massive MIMO, Full Dimensional MIMO (FD-MIMO), an array antenna, analog beam-forming, and large scale antenna technologies are being discussed.

The electronic device may support a multi-antenna transmission scheme (e.g., multiple input multiple output (MIMO)) in order to increase an uplink transmission rate. For example, the electronic device may transmit uplink data through a plurality of antennas agreed with a base station.

The information described above may be provided as the related art for the purpose of enhancing the understanding of the present document. None of the above-mentioned may be asserted as the prior art related to the present document, or used to determine the prior art.

### SUMMARY

In a fifth generation mobile communication (5G) frequency range 2 (FR2) environment, an electronic device 101 may use a communication scheme using a plurality of beams (e.g., multiple-input multiple-output (MIMO) or diversity). The fifth generation mobile communication (5G) frequency range 2 (FR2) environment may include at least 2 frequency ranges. For example, frequency range (FR) 1 band may include a frequency range of 450 MHz to 6 Ghz. Frequency range (FR) 2 band may include a range within 24.25 GHz to 52.6 GHz. The electronic device may use a communication scheme using a plurality of beams in FR 2 band. In order to minimize interference between a plurality of beams, the electronic device 101 may use a vertical (V) pole and a horizontal (H) pole among beam components. Among the beam components, the component corresponding to the V pole and the component corresponding to the H pole are mutually orthogonal components, so interference therebetween is unlikely to occur.

The component corresponding to the V pole (hereinafter, a V component or V beam) and the component corresponding to the H pole (hereinafter, an H component or H beam) are mutually orthogonal components, so, theoretically, interference therebetween is unlikely to occur. However, in an actual environment, due to various factors (e.g., a user's grip, interference of another frequency, or noise), some among components of V pole or H pole may be influenced, thereby causing interference between components of V pole or H pole.

Depending on a user's grip of the electronic device, a degree to which an imbalance between a V component and an H component occurs may vary. In a case in which a user of the electronic device holds, with a hand, a portion in which an antenna is mounted relatively more, a degree of covering the antenna increases, thereby increasing an imbalance between the V component and the H component. In addition, in a case in which a degree to which a user's body covers the antenna increases, the imbalance between the V component and the H component may increase.

Due to such the imbalance, the V beam and the H beam may experience interference even though they are mutually orthogonal components, thereby decreasing a received signal strength.

An electronic device according to an example embodiment may include a processor (comprising processing circuitry, and one or more processors) and a memory. The processor may obtain information related to signal strengths of a plurality of beams by using at least one of an SS/PBCH Block or a channel state information reference signal (CSI-RS) included in a transmission beam, and may obtain information about signal strengths for a vertical (V)-beam component and a horizontal (H)-beam component of the plurality of beams, and may determine a first beam index for the V-beam component based on information related to the obtained signal strength, and may determine a second beam index for the H-beam component based on information related to the obtained signal strength, and may receive a signal by using, among a plurality of beams, a V-beam component of the first beam index and an H-beam component of the second beam index.

A method for operating an electronic device (101) may comprise: obtaining information about received signal strengths of a plurality of beams by using at least one of an SS/PBCH block or a channel state information reference signal (CSI-RS) included in a transmission beam; storing, in a memory, each of received signal strengths for a vertical (V)-beam component and a horizontal (H)-beam component of the plurality of beams; determining a first beam index based on the received signal strength stored in the memory for the V-beam component, and determining a second beam index based on the received signal strength stored in the memory for the H-beam component; and determining a V-beam component of the first beam index and an H-beam component of the second beam index as one beam pair.

The electronic device according to various embodiments of the present document may select beams having best performance such that an imbalance between the V beam and the H beam is minimized in a changing situation of an external environment such as a location of the electronic device, an antenna mounting structure, or a user's grip.

The electronic device according to various embodiments of the present document may improve a quality of a received signal by selecting the beams having best performance.

### BRIEF DESCRIPTION OF DRAWINGS

FIG. 1 is a block diagram of an electronic device in a network environment according to various example embodiments.

FIG. 2 illustrates a block diagram of a configuration of an electronic device according to various example embodiments.

FIG. 3 illustrates a three-stage beam management procedure of an electronic device according to a standard.

FIG. 4 illustrates an example embodiment of an operation for a wireless communication connection between a base station and an electronic device using a directional beam for a wireless connection.

FIG. 5A illustrates a situation in which an imbalance between a V component and an H component occurs in progress of a beam according to an antenna mounting structure of an example electronic device.

FIG. 5B illustrates an example situation in which an imbalance between a V component and an H component occurs in progress of a beam according to a user's grip.

FIGS. 6A-6C illustrate a beam selection process of an electronic device according to a comparative embodiment.

FIG. 7 illustrates a beam selection process of an electronic device according to various example embodiments.

FIG. 8 illustrates a flowchart of a beam selection method of an electronic device according to various example embodiments.

FIG. 9 illustrates a flow diagram of a beam selection method of an electronic device according to various example embodiments.

### DETAILED DESCRIPTION

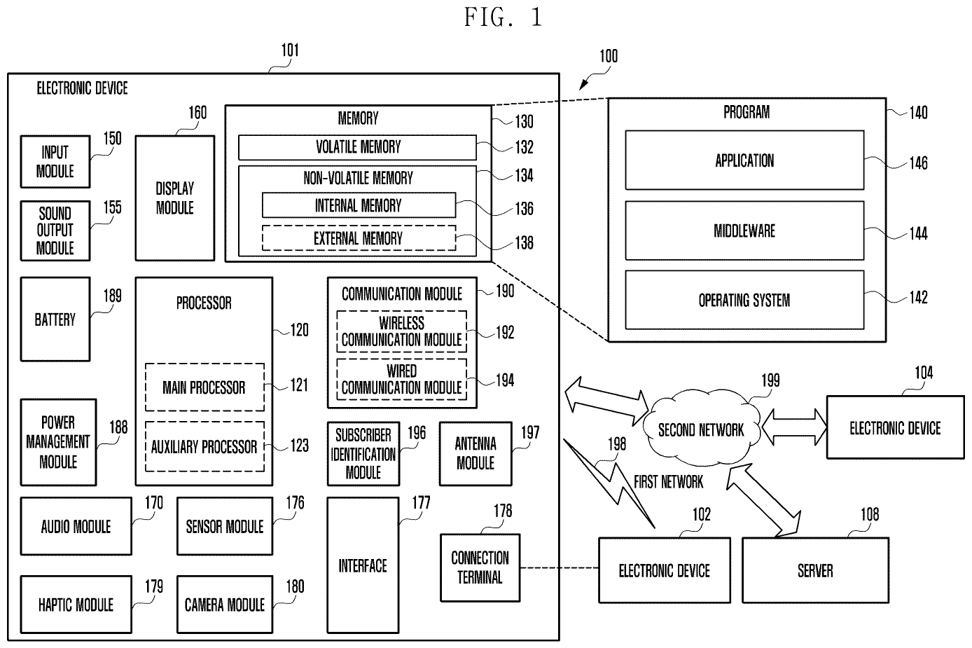

FIG. 1 is a block diagram illustrating an electronic device 101 in a network environment 100 according to various embodiments. Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module(SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thererto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected, directly or indirectly, with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190, comprising communication circuitry, may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as BluetoothTM, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via at least a third element(s).

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

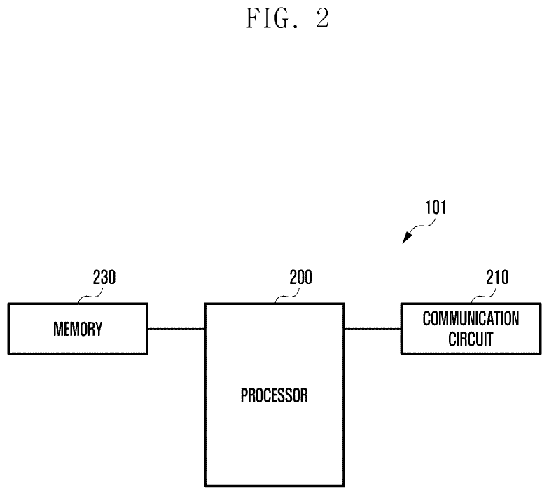

FIG. 2 is a block diagram of an electronic device for searching of a frequency band according to various embodiments. According to one embodiment, the electronic device 101 of FIG. 2 may be at least partially similar to the electronic device 101 of FIG. 1, or may include another embodiment of an electronic device. In the following description, a frequency, as a radio frequency (RF) frequency channel, may include an evolved absolute radio frequency channel number (EARFCN) of an LTE communication scheme and/or an NR-ARFCN of an NR communication scheme.

According to various embodiments with reference to FIG. 2, the electronic device 101 may include a processor 200 (comprising processing circuitry and one or more processors), a communication circuit 210, and/or a memory 230. According to one embodiment, the processor 200 may be substantially identical to the processor 120 of FIG. 1 (e.g., a communication processor), or may be included in the processor 120. The communication circuit 210 may be substantially identical to the wireless communication module 192 of FIG. 1, or may be included in the wireless communication module 192. The memory 230 may be substantially identical to the memory 130 of FIG. 1, or may be included in the memory 130. According to one embodiment, the processor 200 may be connected, directly or indirectly, to the communication circuit 210 and/or the memory 230 operatively, functionally, and/or electrically. Each “processor” herein comprises processing circuitry, and one or more processors.

According to one embodiment, the processor 200 may control the communication circuit 210 to perform searching of all frequencies included in at least one frequency band in which a signal (or energy) is detected. According to one embodiment, in a case in which the processor 200 detects a frequency satisfying a designated signal quality through additional searching, the processor 200 may control the communication circuit 210 to access (or register) to a cell related to the frequency satisfying the designated signal quality. As an example, the signal quality may include at least one of a reference signal received power (RSRP), a reference signal received quality (RSRQ), a received signal strength indicator (RSSI), or a signal to interference plus noise ratio (SINR).

According to various embodiments, the communication circuit 210 may support transmitting and/or receiving of a signal and/or data with at least one external electronic device (e.g., the electronic device 102 or 104 of FIG. 1 or the server 108). According to one embodiment, the communication circuit 210 may include a first communication module and a second communication module. For example, the first communication module may support transmitting and/or receiving of a control message and/or data with a first node (e.g., an NR base station) through a first wireless communication. As an example, the first wireless communication may include a fifth generation communication scheme (e.g., an NR communication scheme). For example, the second communication module may support transmitting and/or receiving of a control message and/or data with a second node (e.g., an LTE base station) through a second wireless communication. As an example, the second wireless communication may include, as a fourth generation communication scheme, at least one of LTE, LTE-advanced (LTE-A), or LTE advanced pro (LTE-A pro). For example, the first communication module and the second communication module may be configured with software processing a signal and a protocol of different frequency bands. For example, the first communication module and the second communication module may be logically (e.g., software) distinguished. For example, the first communication module and the second communication module may be configured with different circuits or different hardware.

According to various embodiments, the memory 230 may store various data used by at least one constituent element of the electronic device 101 (e.g., the processor 200 and/or the communication circuit 210). As an example, the data may include information related to at least one of a cell list of the electronic device 101, a designated first interval, or a designated second interval. As an example, the cell list may include information related to at least one cell to which the electronic device 101 was registered (or accessed) at a previous point in time. According to one embodiment, the memory 230 may store various instructions executable through the processor 200.

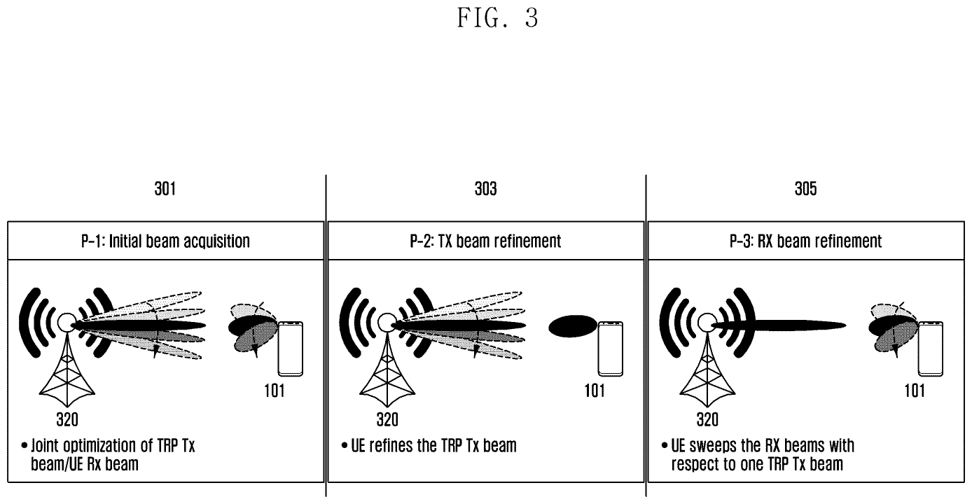

FIG. 3 illustrates a three-stage beam management procedure of an electronic device according to a standard.

An electronic device (e.g., the electronic device 101 of FIG. 1) may transmit and receive a signal by using a radio frequency (RF) beam in a fifth generation mobile communication (5G) frequency range 2 (FR2) environment. The electronic device 101 may use, in a frequency range 2 (FR2) environment, for example, millimeter wave including a frequency band of 24 to 100 GHz.

In a standard (e.g., 3GPP), a three-stage beam management procedure of P1 301, P2 303, and P3 305 is defined.

Before data transmission is activated, in P1 301 stage, a base station 320 may perform periodic synchronization signal block (SSB) beam scanning at a predetermined interval (e.g., an SSB period). The electronic device 101 may select an optimal reception wideband beam (Rx beam) and may report such to the base station 320.

In P2 303 stage of FIG. 3, the base station 320 may sweep a beam of a narrower range than P1. A beam sweeping may indicate an operation of covering an entire cell area while changing a beam to be directed toward another direction of a cell in order to cover a wider cell area by using analog beamforming having a relatively narrow beam width. Alternatively, a beam sweeping may indicate a technology of covering an entire cell area with a series of beams transmitted and received according to a predetermined interval and a predetermined direction in a millimeter wave (mmWave) mobile communication system in the base station 320 and the electronic device 101.

In P2 303 stage of FIG. 3, a beam of a narrowest range is selected, and the base station 320 may transmit, to the electronic device 101, a channel state information-reference signal (CSI-RS) including information about the selected beam. The CSI-RS is a standard/reference signal that the base station 320 may configure flexibly, and may be transmitted periodically, semi-persistently, or aperiodically. The electronic device 101 may measure a channel and a beam strength by using the CSI-RS. The electronic device 101 may update information about a beam transmitted from the base station 320 based on the CSI-RS received from the base station 320.

In P3 305 stage of FIG. 3, the electronic device 101 may select a reception beam of the electronic device 101 corresponding to a transmission beam of the base station 320 of P2 stage by sweeping a beam of a narrower range than P1. A selection process of a reception beam (Rx beam) is a process in the electronic device 101, and the base station 320 may not interfere with P3 stage.

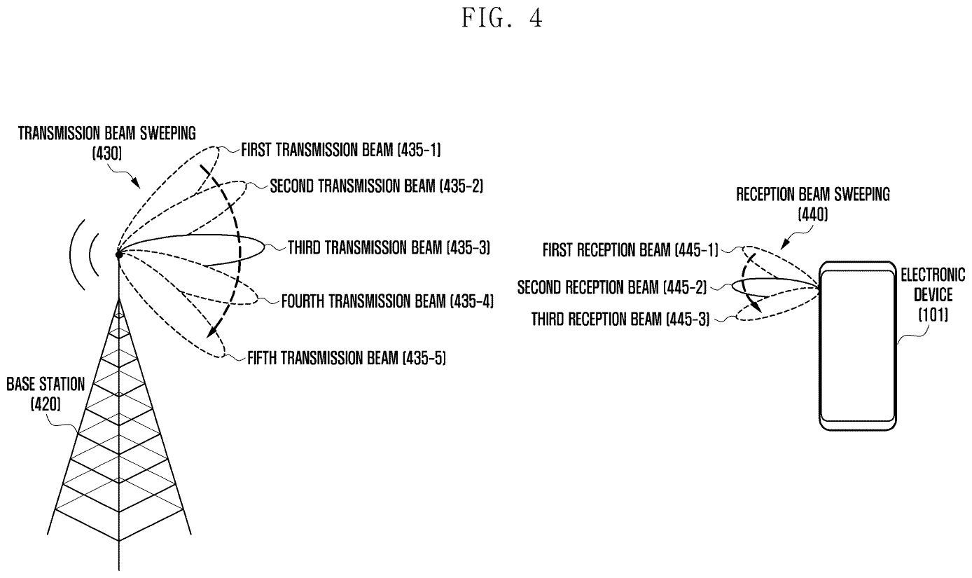

After cell selection in a 5G (NR) environment, the base station 320 may configure synchronization signal block (SSB)/CSI-RS resources for beam management. This will be described in detail in FIG. 4. The electronic device 101 may measure the received signal strength (e.g., reference signal received power (RSRP)) of beams received from the base station 320 by using SSB/CSI-RS, and may update such in the memory 130 connected, directly or indirectly, operatively to the processor 120 (e.g., a communication processor). The processor 120 may select a beam most suitable for receiving a signal based on beam-related data updated in the memory 130. A process of selecting a beam most suitable for receiving a signal based on the beam-related data will be additionally described in FIG. 4.

FIG. 4 illustrates one embodiment of an operation for a wireless communication connection between a base station 420 and an electronic device 101 using a directional beam for a wireless connection.

First, a base station 420 (gNB (gNodeB), transmission reception point (TRP)) may perform a beam detection operation with the electronic device 101 for the wireless communication connection. In an illustrated embodiment, for the beam detection, the base station 420 may perform at least one transmission beam sweeping 430 by sequentially transmitting a plurality of transmission beams, for example, first to fifth transmission beams 435-1 to 435-5 having different directions.

The first to fifth transmission beams 435-1 to 435-5 may include at least one synchronization sequences (SS)/physical broadcast channel (PBCH) block (SS/PBCH block). The SS/PBCH block may be used to periodically measure a channel or a beam strength of the electronic device 101.

In another embodiment, the first to fifth transmission beams 435-1 to 435-5 may include at least one channel state information-reference signal (CSI-RS). The CSI-RS is a standard/reference signal that the base station 420 may configure flexibly, and may be transmitted periodically, semi-persistently, or aperiodically. The electronic device 101 may measure a channel and a beam strength by using the CSI-RS.

The transmission beams may form a radiation pattern having a selected beam width. For example, the transmission beams may have a wide (broad) radiation pattern having a first beam width, or may have a narrow (sharp) radiation pattern having a second beam width narrower than the first beam width. For example, transmission beams including an SS/PBCH block may have a wider radiation pattern than transmission beams including a channel state information-reference signal (CSI-RS).

The electronic device 101 may perform reception beam sweeping 440 while the base station 420 performs the transmission beam sweeping 430. For example, while the base station 420 performs a first transmission beam sweeping 430, the electronic device 101 may fix a first reception beam 445-1 in a first direction and may receive a signal of an SS/PBCH block transmitted from at least one among the first to fifth transmission beams 435-1 to 435-5. While the base station 420 performs a second transmission beam sweeping 430, the electronic device 101 may fix a second reception beam 445-2 in a second direction and may receive a signal of an SS/PBCH block transmitted from the first to fifth transmission beams 435-1 to 435-5. In this way, the electronic device 101 may select, based on a result of a signal reception operation through the reception beam sweeping 440, a communicable reception beam (e.g., a second reception beam 445-2) and a transmission beam (e.g., a third transmission beam 435-3).

As described above, after communicable transmission and reception beams are determined, the base station 420 and the electronic device 101 may transmit and/or receive basic information for configuring a cell, and may configure, based thereon, information for additional beam operation. For example, the beam operation information may include detailed information about a configured beam, an SS/PBCH block, a CSI-RS, or configuration information about an additional reference signal.

In addition, the electronic device 101 may continuously monitor a channel and a beam strength by using at least one of an SS/PBCH block or a CSI-RS included in a transmission beam. The electronic device 101 may adaptively select a beam having good beam quality by using the monitoring operation. Optionally, in a case in which a movement of the electronic device 101 or blocking of a beam occurs and a communication connection is released, a communicable beam may be determined by re-performing the above beam sweeping operation.

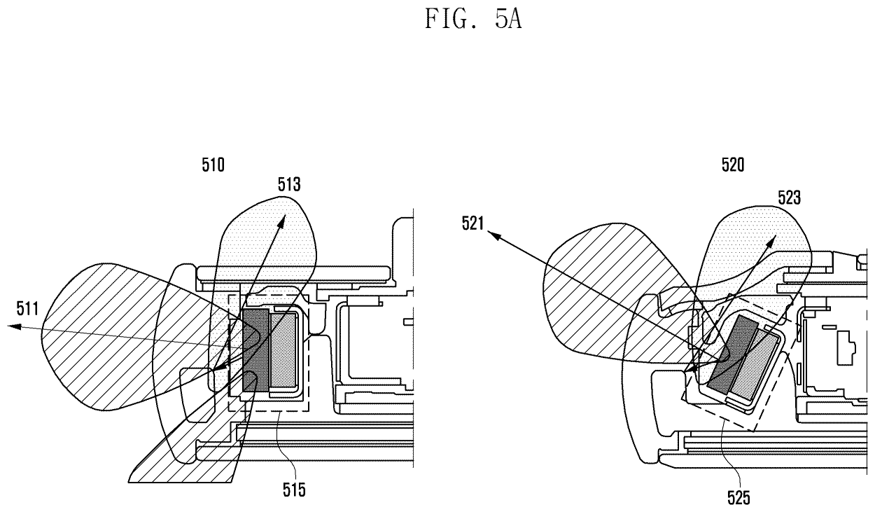

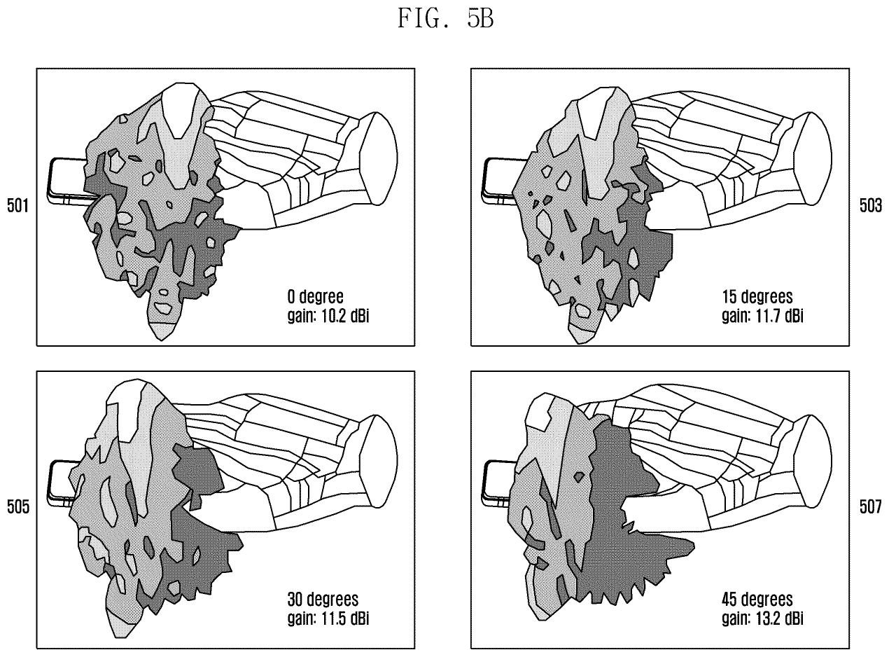

FIG. 5A illustrates a situation in which an imbalance between a V component and an H component occurs in progress of a beam according to an antenna mounting structure of an electronic device.

In a fifth generation mobile communication (5G) frequency range 2 (FR2) environment, an electronic device 101 may use a communication scheme using a plurality of beams (e.g., multiple-input multiple-output (MIMO) or diversity). The electronic device 101 may use a vertical (V) pole and a horizontal (H) pole among beam components in order to minimize interference between a plurality of beams. Among the beam components, the component corresponding to the V pole and the component corresponding to the H pole are mutually orthogonal components, so interference therebetween is unlikely to occur.

The component corresponding to the V pole (hereinafter, a V component or V beam) and the component corresponding to the H pole (hereinafter, an H component or H beam) should have almost no mutual interference because they are mutually orthogonal components, but an imbalance may occur in an actual environment. The imbalance may indicate, for example, that the V component and the H component are not orthogonal to each other. In a case in which the V component and the H component are orthogonal to each other, no mutual interference occurs, but in a case in which the V component and the H component are not orthogonal, interference occurs, thereby causing a signal reception strength to become relatively weak. On the other hand, a balance may indicate, for example, that the V component and the H component are orthogonal to each other.

For example, in drawing 510 of FIG. 5A, according to an antenna 515 mounting structure of an electronic device (e.g., the electronic device 101), a progress direction 511 and a reflected direction 513 of a beam may vary.

In drawing 520 of FIG. 5A, as compared to drawing 510, as an antenna 525 mounting portion is tilted, a progress direction 521 and a reflected direction 523 of a beam may vary. As the progress direction 521 and the reflected direction 523 of the beam vary, a relative phase of a specific component (e.g., a V component and/or an H component) varies, thereby causing an imbalance. As illustrated in drawings 510 and 520, an imbalance between the V beam and the H beam may occur according to a structure in which an antenna of the electronic device 101 is mounted and a location of the electronic device 101. Due to such the imbalance, the V beam and the H beam may experience interference even though the V beam and the H beam are mutually orthogonal components, thereby decreasing a received signal strength.

FIG. 5B illustrates a situation in which an imbalance between a V component and an H component occurs in progress of a beam according to a user's grip.

Depending on a user's grip of the electronic device 101, a degree to which an imbalance between a V component and an H component occurs may vary. In a case in which a user of the electronic device 101 holds, with a hand, a portion in which an antenna is mounted relatively more, a degree of covering the antenna increases, thereby causing a phase between the V component and the H component to vary. For example, in a case in which a degree of covering the antenna increases, a direct component and a component reflected from a hand are combined, thereby causing a relative phase between the V component and the H component to vary and causing an imbalance to occur. In addition, in a case in which a degree to which a user's body covers the antenna increases, a received signal strength may decrease.

Drawings 501, 503, 505, and 507 illustrate a degree of covering an antenna and a signal strength and a direction according thereto in a process in which a user of the electronic device 101 grips the electronic device 101.

Drawing 501 of FIG. 5B illustrates a situation in which a degree of covering an antenna is relatively large such that a signal is received in a narrower direction, and the received signal strength is also relatively weakest. In drawing 501, an angle formed by the electronic device 101 and a user's body (e.g., a wrist) is 0 degree, thereby causing a relatively small empty space. In the case of drawing 501, a user's body interferes with transmitting and receiving of the antenna, thereby obtaining a relatively low antenna gain (e.g., 10.2 dBi).

In drawing 503, an angle formed by the electronic device 101 and a user's body (e.g., a wrist) is 15 degrees, thereby causing a relatively large empty space as compared to drawing 501. In the case of drawing 503, a relatively high antenna gain (e.g., 11.7 dBi) may be obtained as compared to drawing 501.

In drawing 505, an angle formed by the electronic device 101 and a user's body (e.g., a wrist) is 30 degrees, thereby causing a relatively large empty space as compared to drawing 501. In the case of drawing 505, a relatively high antenna gain (e.g., 11.5 dBi) may be obtained as compared to drawing 501.

Drawing 507 of FIG. 5B illustrates a situation in which a degree of covering an antenna is relatively small such that a signal is received in a wider direction, and the received signal strength is also relatively strongest.

In drawing 507, an angle formed by the electronic device 101 and a user's body (e.g., a wrist) is 45 degrees, thereby causing a relatively large empty space as compared to drawing 501. In the case of drawing 507, a relatively high antenna gain (e.g., 13.2 dBi) may be obtained as compared to drawing 501.

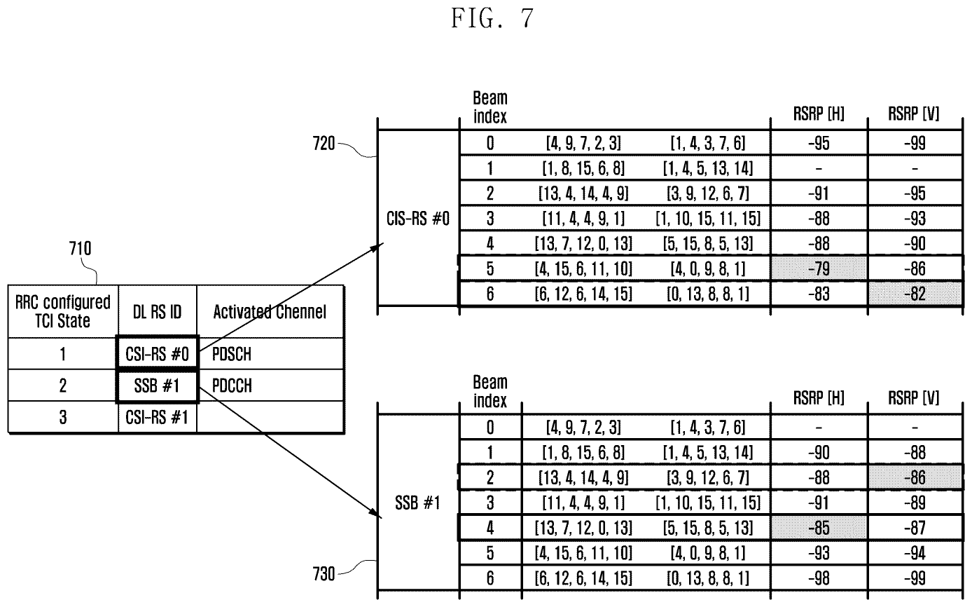

The electronic device 101 according to various embodiments of the present document may select beams having best performance such that an imbalance between the V beam and the H beam is minimized in a changing situation of an external environment such as a location of the electronic device, an antenna mounting structure, or a user's grip. A process of selecting beams having best performance such that an imbalance between the V beam and the H beam is minimized will be described in FIG. 7.

The electronic device 101 may store an RSRP value for each of V-H beams when measuring a beam through SSB and CSI-RS. For example, the electronic device 101 may measure RSRP for each beam index in an SSB slot in 5 ms units and may store the RSRP in a database. In addition, the electronic device 101 may measure RSRP of at least one of SSB or CSI-RS in 20 to 160 ms units and may store the RSRP in the database.

A beam setting timing and a beam index of SSB and CSI-RS may be different from each other, respectively. The electronic device 101 may measure RSRP for each beam setting timing and each beam index, and may store the RSRP in the database. The database may include a storage space in a memory (e.g., the memory 230 of FIG. 2), and may include a storage space in the processor 200.

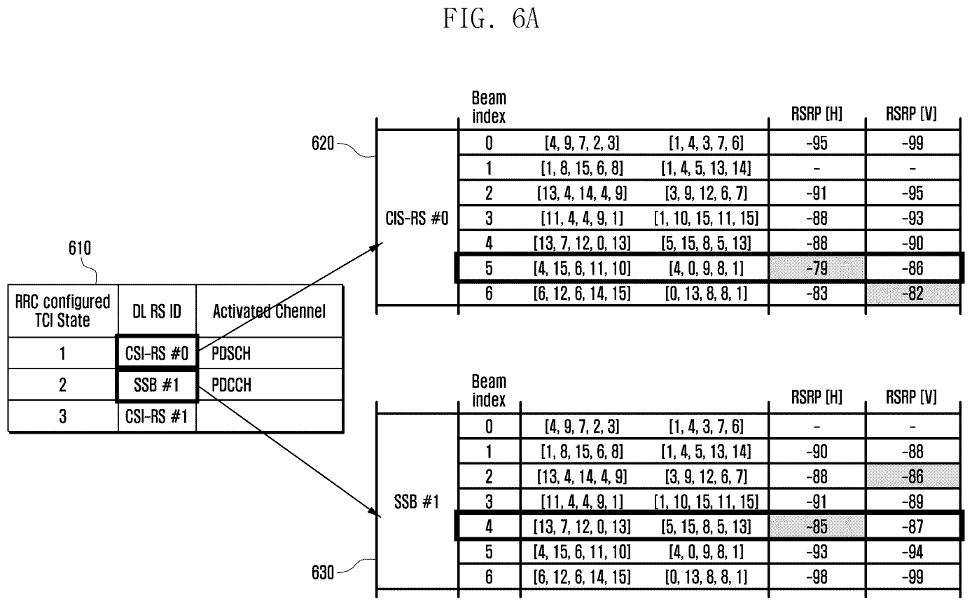

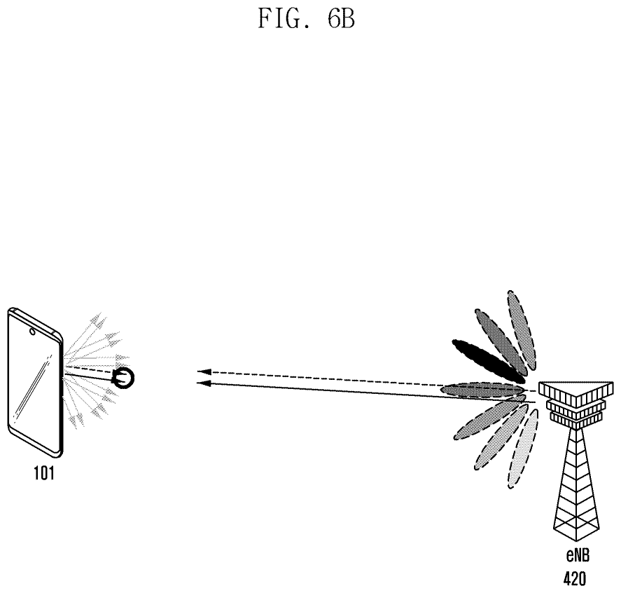

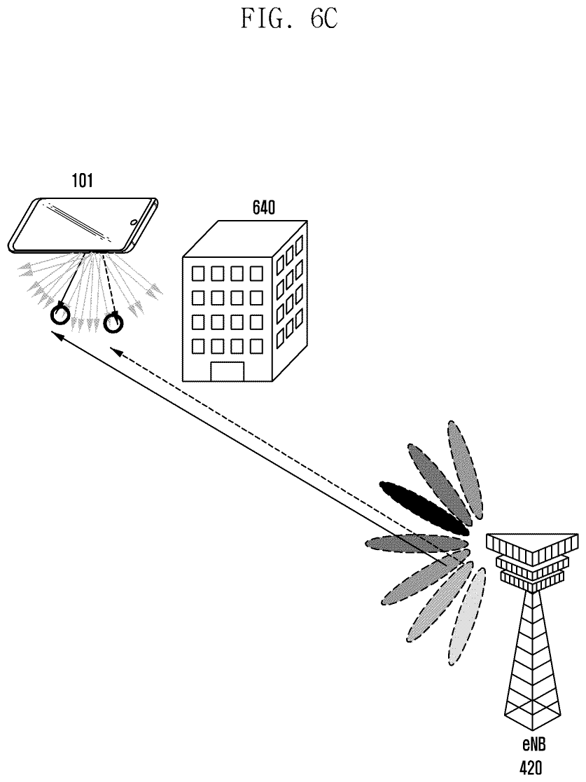

FIGS. 6A-6C illustrate a beam selection process of an electronic device according to a comparative embodiment.

Table 610 of FIG. 6A illustrates an activated channel such that an electronic device (e.g., the electronic device 101 of FIG. 1) may use the activated channel in a reception process. For example, the electronic device 101 may perform communication by using a channel corresponding to CSI-RS #0 or SSB #1. A channel may include a plurality of beams. A beam selection process of the electronic device 101 may be performed in an RX beam tracking process (e.g., P3 305 stage of FIG. 3).

Table 620 of FIG. 6A illustrates seven beams corresponding to CSI-RS #0 by index (index 0 to index 6), and illustrates RSRP of an H beam and RSRP of a V beam of each beam. An H beam may indicate a horizontal (H) pole component in a beam, and a V beam may indicate a vertical (V) pole component in a beam.

According to an embodiment, the electronic device 101 may perform a measurement on a signal corresponding to each slot (e.g., an SSB slot, a CSI-RS slot) and may obtain an RSRP value. The electronic device 101 may update the obtained RSRP value to a database (e.g., beam data table) in real time. Hereinafter, a description is provided in which a data table is stored in a storage space (e.g., a database) included in a communication processor, but the data table may also be stored in another storage means (e.g., the memory 230 of FIG. 2), and the embodiment is not limited thereto.

According to a comparative embodiment, the electronic device 101 may use an index 5 beam in a reception process by considering both RSRP of an H beam and RSRP of a V beam in a situation in which the RSRP of the H beam has best quality for an index 5 beam and the RSRP of the V beam has best quality for an index 6 beam. For example, the electronic device may use a beam index (index 5) corresponding to RSRP (−79, −86) having highest quality when considering both a V beam and an H beam among RSRP values (−95, −91, −88, −88, −79, −83) of an H beam and RSRP values (−99, −95, −93, −90, −86, −82) of a V beam. In a case of an index 6 beam, quality is best for a V beam, but quality is relatively low for an H beam as compared to an index 5 beam, and thus the electronic device may use a beam index (index 5) corresponding to RSRP (−79, −86) having highest quality. However, in a case of using an index 5 beam, as compared to a case of using an index 6 beam, the H beam has quality better by about 4 dbm, but in a V beam, conversely, quality may be worse by about 4 dbm.

Table 630 of FIG. 6A illustrates seven beams corresponding to SSB #1 by index, and illustrates RSRP of an H beam and RSRP of a V beam of each beam.

According to a comparative embodiment, the electronic device 101 may use an index 4 beam in a reception process by comprehensively considering RSRP of an H beam and RSRP of a V beam in a situation in which the RSRP of the H beam has best quality for an index 4 beam and the RSRP of the V beam has best quality for an index 2 beam. The electronic device may use a beam index (index 4) corresponding to RSRP (−85,−87) having highest quality when considering both a V beam and an H beam among RSRP values (−90, −88, −91, −85, −93, −98) of an H beam and RSRP values (−88, −86, −89, −87, −94, −99) of a V beam. In a case of using an index 4 beam, as compared to a case of using an index 2 beam, the H beam has quality better by about 3 dbm, but in a V beam, conversely, quality may be worse by about 1 dbm.

In a case of selecting one beam having best quality when considering both a V beam and an H beam, overall quality is good, but individually performance of a beam may be degraded. For example, in a case of selecting a beam index having highest RSRP of an H beam, a problem may occur in which performance is not exhibited due to relatively low performance of a V beam.

FIG. 7 illustrates a beam selection process of an electronic device according to various embodiments of the present document.

Table 710 of FIG. 7 illustrates an activated channel such that an electronic device (e.g., the electronic device 101 of FIG. 1) may use the activated channel in a reception process. For example, the electronic device 101 may perform communication by using a channel corresponding to CSI-RS #0 or SSB #1. A channel may include a plurality of beams.

Table 720 of FIG. 7 illustrates seven beams corresponding to CSI-RS #0 by index, and illustrates RSRP of an H beam and RSRP of a V beam of each beam. An H beam may indicate a horizontal (H) pole component in a beam, and a V beam may indicate a vertical (V) pole component in a beam.

According to a comparative embodiment illustrated in FIG. 6, the electronic device 101 may use an index 5 beam in a reception process by comprehensively considering RSRP of an H beam and RSRP of a V beam in a situation in which the RSRP of the H beam has best quality for an index 5 beam and the RSRP of the V beam has best quality for an index 6 beam. In a case of using an index 5 beam, as compared to a case of using an index 6 beam, the H beam has quality better by about 4 dbm, but in a V beam, conversely, quality may be worse by about 4 dbm.

According to various embodiments of the present document, the electronic device 101 may use, for receiving a signal, an H beam component of an index 5 beam and simultaneously may use a V beam component of an index 6 beam in a situation in which the RSRP of the H beam has best quality for an index 5 beam and the RSRP of the V beam has best quality for an index 6 beam.

Unlike a comparative embodiment selecting one beam having best performance by adding both RSRP of an H beam and RSRP of a V beam, the electronic device 101 may use a plurality of beams (e.g., an index 5 beam and an index 6 beam) in a reception process. In the present document, a plurality of beams (e.g., an index 5 beam and an index 6 beam) may be referred to as a beam pair. The beam pair may indicate a combination of a first beam having best reception performance for an H beam among a plurality of beam indices and a second beam having best reception performance for a V beam. The electronic device may also receive a signal by selecting one beam index instead of a beam pair in a case in which one beam index has best reception performance of an H beam and a V beam among a plurality of beam indices.

As compared to a case of using an index 5 beam according to a comparative embodiment, performance of an H beam is identical, but in a V beam, quality for a received signal may be improved by about 4 dbm by using an index 6 beam.

Table 730 of FIG. 7 illustrates seven beams corresponding to SSB #1 by index, and illustrates RSRP of an H beam and RSRP of a V beam of each beam.

According to a comparative embodiment illustrated in FIG. 6, the electronic device 101 may use an index 4 beam in a reception process by comprehensively considering RSRP of an H beam and RSRP of a V beam in a situation in which the RSRP of the H beam has best quality for an index 4 beam and the RSRP of the V beam has best quality for an index 2 beam. In a case of using an index 4 beam, as compared to a case of using an index 2 beam, the H beam has quality better by about 3 dbm, but in a V beam, conversely, quality may be worse by about 1 dbm.

According to various embodiments of the present document, the electronic device 101 may use an H beam component of an index 4 beam and simultaneously may use a V beam component of an index 2 beam in a situation in which the RSRP of the H beam has best quality for an index 4 beam and the RSRP of the V beam has best quality for an index 2 beam.

Unlike a comparative embodiment selecting one beam pair having best performance by adding both RSRP of an H beam and RSRP of a V beam, the electronic device 101 may use a plurality of beams (e.g., an index 4 beam and an index 2 beam) in a reception process. In a process of receiving a signal transmitted from a base station, the electronic device may receive a signal by using a communication circuit and by using a selected beam index.

As compared to a case of using an index 4 beam according to a comparative embodiment, performance of an H beam is identical, but in a V beam, quality for a received signal may be improved by about 1 dbm by using an index 2 beam.

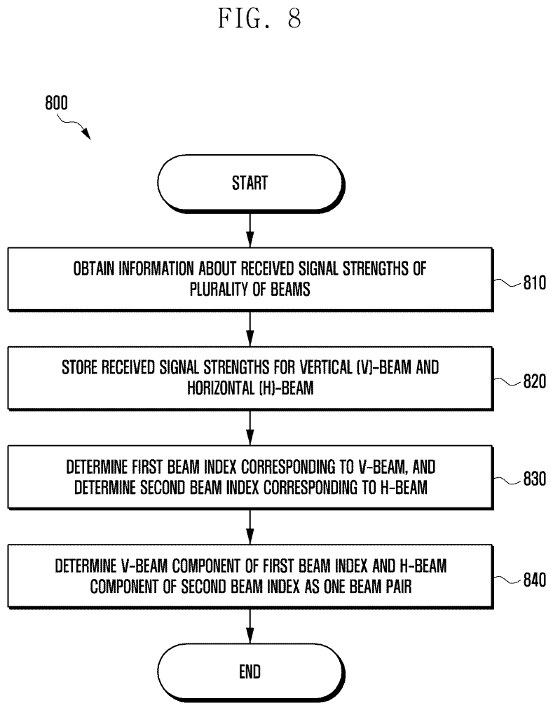

FIG. 8 illustrates a flowchart of a beam selection method of an electronic device according to various embodiments of the present document.

The operations described through FIG. 8 may be implemented based on instructions capable of being stored in a computer-readable medium or memory (e.g., the memory 130 of FIG. 1). An illustrated method 800 may be executed by an electronic device (e.g., the electronic device 101 of FIG. 1) described above through FIG. 1 to FIG. 7, and technical features described above are to be omitted below. An order of each operation of FIG. 8 may be changed, some operations may be omitted, and some operations may be performed simultaneously.

In operation 810 of FIG. 8, a processor (e.g., the processor 120 of FIG. 1) may obtain (or acquire) information about received signal strengths of a plurality of beams.

The processor 120 may obtain information about received signal strengths of a plurality of beams by using at least one of an SS/PBCH block or a channel state information reference signal (CSI-RS) included in a transmission beam. After communicable transmission and reception beams are determined as illustrated in FIG. 3, a base station (e.g., a base station 420 of FIG. 4) and the electronic device 101 may transmit and/or receive basic information for configuring a cell. The base station 420 and the electronic device 101 may configure information for additional beam operation based on transmitted and received information. For example, the beam operation information may include detailed information about a configured beam, an SS/PBCH block, a CSI-RS, or configuration information about an additional reference signal.

In addition, the electronic device 101 may continuously monitor a channel and a beam strength by using at least one of an SS/PBCH block or a CSI-RS included in a transmission beam. The SS/PBCH block may be named a synchronization signal block (SSB). The CSI-RS is a standard/reference signal that the base station 420 may configure flexibly, and may be transmitted periodically, semi-persistently, or aperiodically. The processor 120 may measure a received signal strength by using the CSI-RS received from the base station 420. The processor 120 may measure a received signal strength (e.g., RSRP) by using a signal (e.g., an SS/PBCH block, CSI, CSI-RS) included in a transmission beam.

In operation 820 of FIG. 8, the processor 120 may store, as a table in the memory 130, received signal strengths for vertical (V)-beam and horizontal (H)-beam.

In a fifth generation mobile communication (5G) frequency range 2 (FR2) environment, an electronic device 101 may use a communication scheme using a plurality of beams (e.g., multiple-input multiple-output (MIMO) or diversity). The electronic device 101 may use a vertical (V) pole and a horizontal (H) pole among beam components in order to minimize interference between a plurality of beams.

In operation 830 of FIG. 8, the processor 120 may determine a first beam index corresponding to a V-beam and may determine a second beam index corresponding to an H-beam. According to one embodiment, the processor 120 may determine, as the first beam index, a beam having best RSRP among at least one V-beam. In addition, the processor 120 may determine, as the second beam index, a beam having best RSRP among at least one H-beam.

The first beam index may indicate, for example, a beam index of one among seven beams. The number of beams is only one example and is not limited to seven, and may vary according to the configuration. The second beam index is a beam index distinguished from the first index, and may indicate a beam index of one among seven beams. Likewise, the number of beams is only one example and is not limited to seven, and may vary according to the configuration. The first beam index corresponding to a V-beam may be determined based on RSRP. The electronic device 101 may determine, as the first beam index, an index of a beam having best RSRP among V-beams. Likewise, the electronic device 101 may determine, as the second beam index, an index of a beam having best RSRP among H-beams.

For example, as described in FIG. 7, the electronic device 101 may determine to use an H beam component of an index 5 beam and simultaneously to use a V beam component of an index 6 beam in a situation in which RSRP of an H beam has best quality for an index 5 beam and RSRP of a V beam has best quality for an index 6 beam. In this case, the first beam index corresponding to a V-beam may indicate an index 6 beam, and the second beam index corresponding to an H beam may indicate an index 5 beam. The first beam index and the second beam index may vary according to the number of beams and a received signal strength of each beam component.

In operation 840 of FIG. 8, the processor 120 may determine, as one beam pair, a V-beam component of the first beam index and an H-beam component of the second beam index.

According to a comparative embodiment illustrated in FIG. 6, the electronic device 101 may use an index 5 beam in a reception process by comprehensively considering RSRP of an H beam and RSRP of a V beam in a situation in which the RSRP of the H beam has best quality for an index 5 beam and the RSRP of the V beam has best quality for an index 6 beam. In a case of using an index 5 beam, as compared to a case of using an index 6 beam, the H beam has quality better by about 4 dbm, but in a V beam, conversely, quality may be worse by about 4 dbm.

On the other hand, according to various embodiments of the present document, the electronic device 101 may use an H beam component of an index 5 beam and simultaneously may use a V beam component of an index 6 beam in a situation in which RSRP of an H beam has best quality for an index 5 beam and RSRP of a V beam has best quality for an index 6 beam. That is, the electronic device 101 may determine, as one beam pair, a V-beam component of the first beam index (e.g., an index 6 beam) and an H-beam component of the second beam index (e.g., an index 5 beam). The electronic device 101 may determine, as one beam pair, a V-beam component of the first beam index (e.g., an index 6 beam) and an H-beam component of the second beam index (e.g., an index 5 beam), and may use such for receiving a signal of the base station 420. The electronic device 101 may improve a received signal strength and may improve communication quality by selecting a beam index having best performance for each beam component.

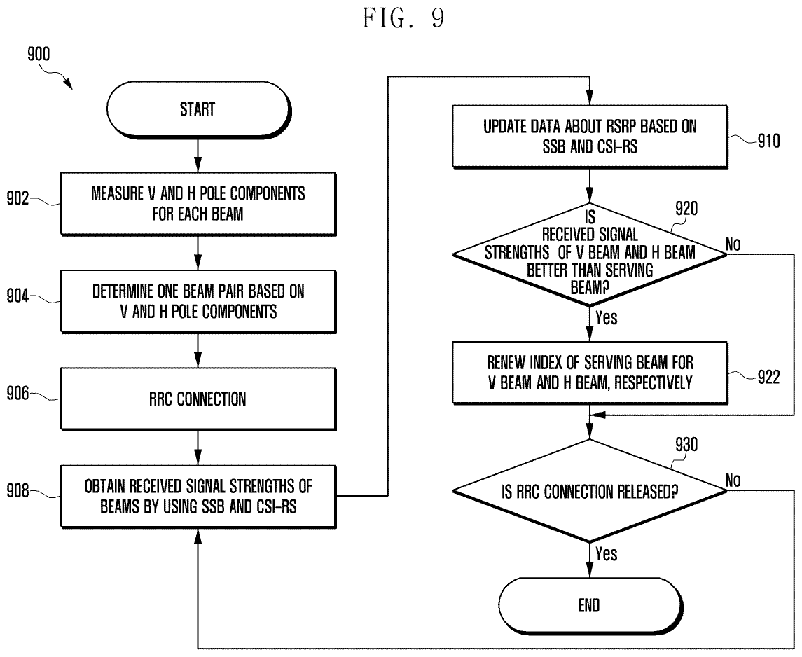

FIG. 9 illustrates a flow diagram of a beam selection method of an electronic device according to various embodiments of the present document.

The operations described through FIG. 9 may be implemented based on instructions that may be stored in a computer-readable medium or a memory (e.g., the memory 130 of FIG. 1). An illustrated method 900 may be executed by an electronic device (e.g., the electronic device 101 of FIG. 1) described above through FIG. 1 to FIG. 7, and technical features described above are to be omitted below. An order of each operation of FIG. 9 may be changed, some operations may be omitted, and some operations may be performed simultaneously.

In operation 902 of FIG. 9, a processor (e.g., the processor 120 of FIG. 1) may measure received signal strengths of a V component and an H component for each of beams included in a channel.

In operation 904 of FIG. 9, the processor 120 may determine one beam pair based on V and H pole components. The processor 120 may determine one beam pair having an overall highest received signal strength by considering both received signal strength of a V component and a H component. This has been described in FIG. 6. One beam pair having an overall highest received signal strength may have, in an individual component, a received signal strength relatively low as compared to a beam having another index.

For example, according to a comparative embodiment illustrated in FIG. 6, the electronic device 101 may use an index 5 beam in a reception process by comprehensively considering RSRP of an H beam and RSRP of a V beam in a situation in which RSRP of an H beam has best quality for an index 5 beam and RSRP of a V beam has best quality for an index 6 beam. In a case of using an index 5 beam, as compared to a case of using an index 6 beam, the H beam has quality better by about 4 dbm, but in a V beam, conversely, quality may be worse by about 4 dbm.

In operation 906 of FIG. 9, the processor 120 may determine one beam pair having an overall highest received signal strength, and may establish an RRC connection with a base station (e.g., the base station 420 of FIG. 4) by using the determined beam.

In operation 908 of FIG. 9, the processor 120 may obtain information about received signal strengths of a plurality of beams by using at least one of an SS/PBCH block or a channel state information reference signal (CSI-RS) included in a transmission beam. The base station 420 and the electronic device 101 may configure information for additional beam operation based on transmitted and received information. For example, the beam operation information may include detailed information about a configured beam, an SS/PBCH block, a CSI-RS, or configuration information about an additional reference signal.

In addition, the electronic device 101 may continuously monitor a channel and a beam strength by using at least one of an SS/PBCH block or a CSI-RS included in a transmission beam. The processor 120 may measure a received signal strength by using the CSI-RS received from the base station 420. The processor 120 may measure a received signal strength (e.g., RSRP) by using a signal (e.g., an SS/PBCH block, CSI, CSI-RS) included in a transmission beam.

In operation 910 of FIG. 9, the processor 120 may update data about a received signal strength (e.g., RSRP) based on an SS/PBCH block or a channel state information reference signal (CSI-RS) included in a transmission beam.

In operation 920 of FIG. 9, the processor 120 may determine, respectively, whether received signal strengths of a V beam and an H beam are better than a current serving beam. The processor 120 may compare a received signal strength of a V beam with a V beam component of the current serving beam, and may compare a received signal strength of an H beam with an H beam component of the current serving beam.

In operation 922 of FIG. 9, the processor 120 may change (or renew) an index of the serving beam based on at least one beam component among a V beam and an H beam having RSRP higher as compared to a component of the serving beam (operation 920-Yes). The electronic device 101 may further include a memory (e.g., the memory 230 of FIG. 2) storing an index of the serving beam. The electronic device 101 may store an index of the serving beam in the memory 230, and may update a changed (or renewed) index value of the serving beam based on an RSRP value. In a case in which both a V beam component and an H beam component have received signal strengths not better than the serving beam, the processor 120 may perform operation 930 of FIG. 9.

According to a comparative embodiment illustrated in FIG. 6, the electronic device 101 may use an index 4 beam in a reception process by comprehensively considering RSRP of an H beam and RSRP of a V beam in a situation in which the RSRP of the H beam has best quality for an index 4 beam and the RSRP of the V beam has best quality for an index 2 beam. In a case of using an index 4 beam, as compared to a case of using an index 2 beam, the H beam has quality better by about 3 dbm, but in a V beam, conversely, quality may be worse by about 1 dbm.

According to various embodiments of the present document, the electronic device 101 may use an H beam component of an index 4 beam and simultaneously may use a V beam component of an index 2 beam in a situation in which the RSRP of the H beam has best quality for an index 4 beam and the RSRP of the V beam has best quality for an index 2 beam.

That is, in a situation in which the electronic device 101 has been using an index 4 beam, the electronic device 101 may change a used beam to an index 2 beam based on a received signal strength of the index 2 beam being better for a V beam component. The electronic device 101 may maintain using an index 4 beam for an H beam component.

In operation 930 of FIG. 9, the processor 120 may identify whether an RRC connection is released. The processor 120, comprising processing circuitry and one or more processors, may terminate an illustrated method 900 based on an RRC connection being released (operation 930—Yes). Alternatively, the processor 120 may perform operation 908 again based on an RRC connection not being released (operation 930—No). In operation 908 of FIG. 9, the processor 120 may obtain information about received signal strengths of a plurality of beams by using at least one of an SS/PBCH block or a channel state information reference signal (CSI-RS) included in a transmission beam. “Based on” as used herein covers based at least on.

According to one embodiment, the processor 120 may include a communication processor. The processor 120 may store received signal strengths of a vertical (V)-beam component and a horizontal (H)-beam component of a plurality of beams in the memory 130 or may store the received signal strengths in a storage space in the processor 120.

According to one embodiment, the processor 120 may determine a first beam index and a second beam index based on received signal strengths of a vertical (V)-beam component and a horizontal (H)-beam component of a plurality of beams, and may update information about the plurality of beams.

According to one embodiment, the processor 120 may obtain an RSRP value by performing a measurement on a signal corresponding to each slot, and may update the obtained RSRP value in a database in real time. Each slot may include at least one of an SSB slot or a CSI-RS slot.

According to one embodiment, the processor 120 may perform beam selection based on a beam strength of a reception beam (RX beam) in a tracking process of the reception beam.

1. An electronic device comprising:
a processor comprising processing circuitry; and
a memory,
wherein the processor is configured to:
obtain information about received signal strengths of a plurality of beams using at least one of a channel state information reference signal (CSI-RS) or an SS/PBCH block included in a transmission beam;
store, in the memory, each of received signal strengths for a vertical (V)-beam and a horizontal (H)-beam of the plurality of beams;
determine a first beam index based on value of the received signal strength for the V-beam;
determine a second beam index based on value of the received signal strength for the H-beam; and
determine a V-beam component of the first beam index and an H-beam component of the second beam index as a beam pair.

2. The electronic device of claim 1, wherein the received signal strength comprises one selected from among a reference signal received power (RSRP), a received signal strength indicator (RSSI), a reference signal received quality (RSRQ), or a signal to interference plus noise ratio (SINR).

3. The electronic device of claim 1, wherein the processor comprises one or more processors and is configured to:
select some reception beams from among the plurality of receptions beams;
measure the received signal strength of the selected reception beam; and
based on the measured reception signal strength, compile the received signal strengths for the vertical (V)-beam and horizontal (H)-beam corresponding to each beam into a table and store the table in the memory.

5. The electronic device of claim 1, wherein the processor is configured to:
determine the V-beam component of the first beam index and the H-beam component of the second beam index as a beam pair; and
use a plurality of beams corresponding to the first beam index and the second beam index in a signal reception process of a base station.

5. The electronic device of claim 1, wherein the processor is configured to configure information for additional beam operation using at least one of the channel state information reference signal (CSI-RS) or the SS/PBCH block included in the transmission beam, and
wherein the beam operation information comprises detailed information about a configured beam, and configuration information about the SS/PBCH block, the CSI-RS, and/or an additional reference signal.

5. The electronic device of claim 1, wherein the processor is configured to continuously monitor a channel and a beam strength using at least one of the channel state information reference signal (CSI-RS) or the SS/PBCH block included in the transmission beam,
wherein the SS/PBCH block refers to a synchronization signal block (SSB), and
wherein the CSI-RS is a standard/reference signal that can be flexibly configured by a base station, and is transmitted periodically/semi-periodically and/or aperiodically.

7. The electronic device of claim 1, wherein the first beam index corresponding to the V-beam is determined as a beam having highest RSRP of a V-beam component among a plurality of beams.

8. The electronic device of claim 1, wherein the second beam index corresponding to the H-beam is determined as a beam having highest RSRP of an H-beam component among a plurality of beams.

9. The electronic device of claim 1, wherein the processor comprises a communication processor, and stores received signal strengths for a vertical (V)-beam component and a horizontal (H)-beam component of a plurality of beams in the memory, and/or stores the received signal strengths in a storage space in the processor.

10. The electronic device of claim 9, wherein the processor is configured to determine the first beam index and the second beam index based on the received signal strengths for the vertical (V)-beam component and the horizontal (H)-beam component of the plurality of beams, and update information about the plurality of beams stored in the memory and/or stored in the storage space in the processor.

11. The electronic device of claim 1, wherein the processor is configured to obtain an RSRP value by performing a measurement on a signal corresponding to each slot, and update the obtained RSRP value in a database in real time, and
wherein each slot comprises at least one of an SSB slot or a CSI-RS slot.

12. The electronic device of claim 1, wherein the processor is configured to perform beam selection based on a beam strength of a reception beam (RX beam) in a tracking process of the reception beam.

13. A method for operating an electronic device, the method comprising:
obtaining information about received signal strengths of a plurality of beams using at least one of an SS/PBCH block or a channel state information reference signal (CSI-RS) included in a transmission beam;
storing, in a memory, each of received signal strengths for a vertical (V)-beam component and a horizontal (H)-beam component of the plurality of beams;
determining a first beam index based on the received signal strength stored in the memory for the V-beam component, and determining a second beam index based on the received signal strength stored in the memory for the H-beam component; and
determining a V-beam component of the first beam index and an H-beam component of the second beam index as a beam pair.

14. The method of claim 13, wherein the received signal strength comprises at least one selected from among a reference signal received power (RSRP), a received signal strength indicator (RSSI), a reference signal received quality (RSRQ), or a signal to interference plus noise ratio (SINR).

15. The method of claim 13, further comprising:
selecting some reception beams from among a plurality of reception beams;
measuring a received signal strength of the selected reception beam; and
storing, as a database, based on the measured received signal strength, received signal strengths for a vertical (V)-beam component and a horizontal (H)-beam component corresponding to each beam in a memory associated with a processor.

16. The method of claim 13, wherein the determining of the V-beam component of the first beam index and the H-beam component of the second beam index as the beam pair comprises:
receiving a signal of a base station using a plurality of beams corresponding to the first beam index and the second beam index.

17. The method of claim 13, further comprising:
configuring information for additional beam operation using at least one of the SS/PBCH block or the channel state information reference signal (CSI-RS) included in the transmission beam,
wherein beam operation information comprises detailed information about a configured beam, and configuration information about at least one of the SS/PBCH block, the CSI-RS, or an additional reference signal.

18. The method of claim 13, further comprising:
continuously monitoring a channel and a beam strength using at least one of the SS/PBCH block or the CSI-RS included in the transmission beam,
wherein the SS/PBCH block refers to a synchronization signal block (SSB), and
wherein the CSI-RS is a standard/reference signal that can be flexibly configured by a base station, and is transmitted periodically/semi-periodically and/or aperiodically.

19. The method of claim 13, wherein the first beam index corresponding to a V-beam is determined as a beam having highest RSRP of a V-beam component among a plurality of beams.

20. The method of claim 13, wherein the second beam index corresponding to a H-beam is determined as a beam having highest RSRP of an H-beam component among a plurality of beams.
